(19) United States
(12) Patent Application Publication
(10) Pub. No.: US 2008/0059907 A1
(43) Pub. Date: Mar. 6, 2008

(54) SAVING THE CONTENTS OF THE TRACK LIST AS A PLAYLIST FILE

(76) Inventors: Kari Jakobsson, Turku (FI); Janne M. Martama, Salo (FI); Jaakko Arvilommi, Turku (FI)

Correspondence Address: PERMAN & GREEN, 425 POST ROAD, FAIRFIELD, CT, 06824, US

(21) Appl. No.: 11/469,580

(22) Filed: Sep. 1, 2006

(51) Int. Cl. G06F 3/048

(52) U.S. Cl. 715/841; 715/764

(57) ABSTRACT

A method is disclosed that includes browsing a media library for desired media items; selecting found desired media items from the media library; and saving the selected media items as a play list. Existing play lists can be opened and edited by the browsing and selecting. Applications, apparatuses and computer programs for implementing the method are also disclosed.

### TECHNICAL FIELD

The disclosed embodiments relate to methods for saving a play list in a portable apparatus, a saving application, a portable apparatus comprising a display and means for navigating, and a computer-readable medium having computer-executable components.

### BACKGROUND OF THE INVENTION

Many times, items are stored in a device with processing and storage capabilities, such as a computer, a media player, and nowadays also mobile communication apparatuses, arranged in a hierarchical tree structure. The items in the tree structure are assigned a hierarchical level, and each item, except items on the top or ‘root’ level, is associated with another item on a higher level. As the number of items increases, and/or the complexity of the tree structure increases, it becomes more cumbersome for a user to manage browsing the items and to keep track of its position in the hierarchical tree structure. This is especially problematic in an apparatus with a small physical size, since the display of the device accordingly provides less displaying area. U.S. Pat. No. 6,928,433 B2, which is hereby incorporated by reference, discloses a solution for organizing and selecting tracks for a playlist in a portable music player. However, it is believed that improvements can be made that facilitates for a user to

### SUMMARY

In view of the above, it would be advantageous to solve or at least reduce the problems discussed above and provide a user friendly and efficient browsing and saving of items in a portable apparatus.

According to a first aspect of the disclosed embodiments, there is provided a method comprising browsing a media library for desired media items; selecting found desired media items from said media library; and saving the selected media items as a play list.

The browsing and selecting may comprise displaying a first list of items belonging to a dimension of said multi-dimensional hierarchy in a display view; displaying a second list of items representing other dimensions of said multi-dimensional hierarchy in said display view; enabling selection of a displayed item; upon selection of an item from said first list, displaying a third list of items belonging to a lower hierarchical level for enabling further selection of displayed items, wherein said third list is hierarchically associated with the selected item; and upon selection of an item from said second list, displaying a fourth list of items belonging to a dimension of said multi-dimensional hierarchy associated with the selected item.

The method may further comprise rendering a media item associated with said selected item upon selection of a media item.

The method may further comprise indenting said inserted third list compared to said first list.

The method may further comprise, upon selection of an item from said second list, concealing said first list of items; and inserting into said second list of items an item representing the dimension of said concealed first list.

According to a second aspect of the disclosed embodiments, there is provided an application comprising a browser for a media library; a selector for selecting found desired media items from said media library; and a saver for saving the selected media items in a memory as a play list.

The browser may cause a first list of items belonging to a dimension of a multi-dimensional hierarchy to be displayed, and a second list of items representing other dimensions of said multi-dimensional hierarchy to be displayed, wherein the browser may be capable of receiving a selection of a displayed item, and upon selection of an item from said first list, cause a third list of items belonging to a lower hierarchical level to be displayed for enabling further selection of displayed items, wherein said third list is hierarchically associated with the selected item; and upon selection of an item from said second list, a fourth list of items belonging to a dimension of said multi-dimensional hierarchy associated with the selected item to be displayed.

According to a third aspect of the disclosed embodiment, there is provided a portable apparatus arranged to enable navigation among items displayed on said display, the apparatus further comprising a browser for a media library; a selector for selecting found desired media items in said media library; and a saver for saving the selected media items in a memory as a play list.

According to a fourth aspect of the disclosed embodiments, there is provided a computer-readable medium having computer-executable components comprising instructions for browsing a media library for desired media items; selecting found desired media items; and saving the selected media items as a play list.

The second, third, and fourth aspects may be embodied with similar features as those demonstrated for the first aspect.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other features and advantages of the disclosed embodiments will appear from the following detailed disclosure, from the attached dependent claims as well as from the drawings.

### BRIEF DESCRIPTION OF THE DRAWINGS

The above, as well as additional features and advantages of the disclosed embodiments, will be better understood through the following illustrative and non-limiting detailed description of preferred embodiments, with reference to the appended drawings, where the same reference numerals will be used for similar elements, wherein:

FIG. 1 shows an exemplary environment in which the disclosed embodiments can be used;

FIG. 2 is an example of displaying items;

FIG. 3 shows a part of an exemplary hierarchical structure;

FIG. 4 is a flow chart illustrating a method according to an embodiment;

FIG. 5 illustrates an example of a display view;

FIG. 6 shows an embodiment;

FIG. 7 shows an example of a hierarchical tree structure;

FIG. 8 shows an example with visual cues;

FIG. 9 shows an alternative example with visual cues;

FIG. 10 shows an example according to another embodiment;

FIG. 11 is a schematic flow chart illustrating another embodiment; and

FIG. 12 is a schematic flow chart illustrating an embodiment.

### DETAILED DESCRIPTION OF EMBODIMENTS

FIG. 1 shows an exemplary environment, in which the disclosed embodiments can be used, in form of a mobile communication apparatus 100 comprising a display 102 and means 104 for navigating among items (not shown) displayed in a display area 102. The navigation means 104 can be a rotating input, a joystick, a touch pad, but can also be implemented using a touch sensitive display, wherein the displayed items directly can be tapped by a user for selection, or be voice activated via a headset or a built-in microphone. The mobile communication apparatus can also comprise other elements normally present in such an apparatus, such as a keypad 106, a speaker 108, a microphone 110, a processor (not shown), a memory (not shown), etc.

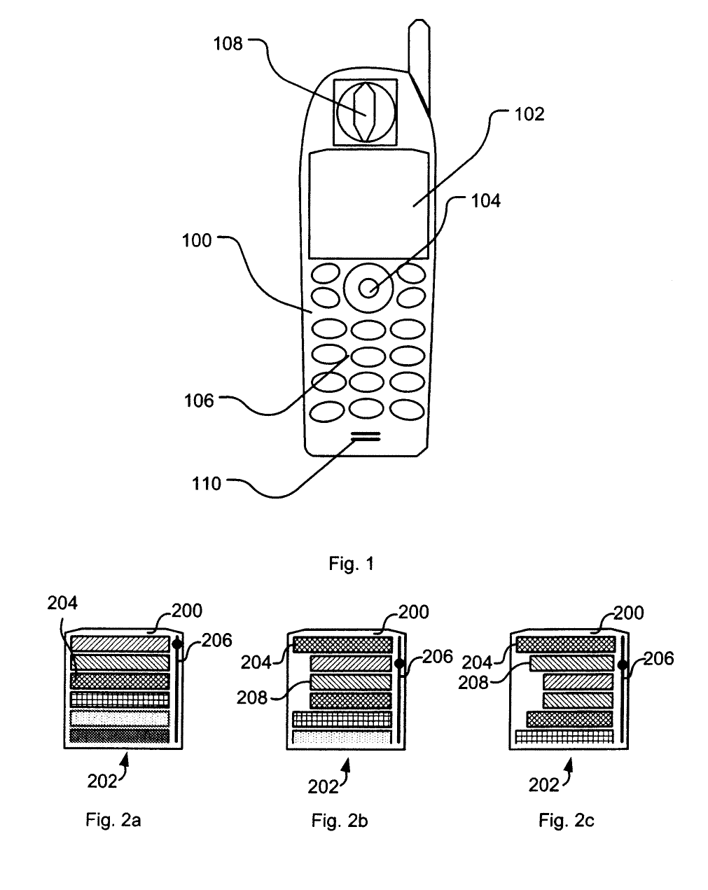

FIG. 2 shows the displaying of items 202 on a display 200 in the form of a list, wherein FIG. 2a shows the display 200 displaying a number of items, indicated by the patterned bars, in a first list. Assume that the third uppermost item 204 is selected. The selected item 204 will preferably be displayed on the top of the display view and the entire items list is thus scrolled, indicated by the scroll bar 206, in such way that the selected item 204 ends up on the top of the display view, as shown in FIG. 2b. Further, upon selection of the item 204, a second list of items is inserted between the selected item 204 and the successive items of the first list in the display view, illustrated in FIG. 2b, wherein the items of the second list are hierarchically associated with the selected item 204. The hierarchically associations with item 204 can further be emphasized by e.g. indenting the second list of items as shown in FIG. 2b. A user is thus also enabled to select items also from the second list. If the selected item 204 is re-selected in the state shown in FIG. 2b, the second list is preferably concealed, and the view according to FIG. 2a is once again displayed. If another item from the first list is selected in the state shown in FIG. 2b, another indented list of items is inserted between the another selected item and the successive items of the first list, wherein the items of the another indented list are hierarchically associated with the other selected item. If an item 208 from the second list is selected, either information associated with the item 208 is renderable, e.g. playing a media clip, or a third indented list of items is inserted between the selected item 208 and the following items, as is illustrated in FIG. 2c, wherein the items of the third list are hierarchically associated with the selected item 208. Depending on the number of levels in the hierarchy the item selection and list insertion can continue in the same manner until the lowest level in the hierarchy is reached.

For facilitating navigation of long item lists, a scroll bar 206 can be displayed on the display 200.

The items in FIG. 2 have been assigned patterns instead of real information text to make the disclosure more clear and not to obstruct the principle by text examples only giving understanding to few familiar with knowledge of relations between the items of an example. Similarities between patterns in items in different hierarchical levels are not an illustration of relationship. Thus, same pattern in same hierarchical level illustrates that it is the same item, and items placed below another item but with a slight indent illustrates hierarchical relationship with the item above.

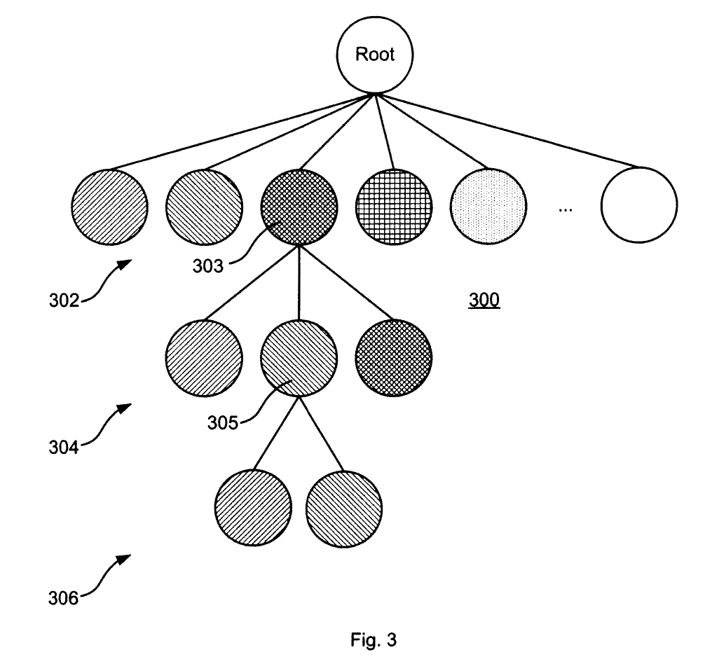

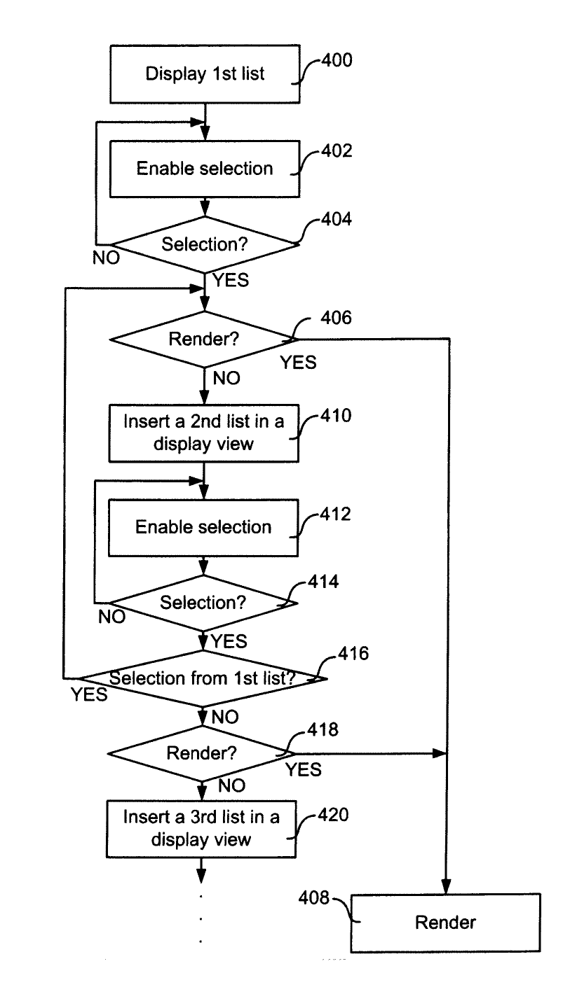

To illustrate the hierarchy in the example in FIG. 2, FIG. 3 shows a part of the hierarchical structure 300 in the example, wherein the structure can be considered to have an imaginary ‘root’ under which all of the top items 302 belonging to the highest level of the structure. Among these top items 302, we take a closer look at item 303, which is hierarchically associated to items 304 at the one step lower level in the hierarchy. Among these items 304, we take a closer look at item 305, which is hierarchically associated to items 306 at the further one step lower level in the hierarchy. As readily can be seen, the above discussed items 302-306 correspond to the items displayed in the example of FIG. 2.

FIG. 4 is a flow chart illustrating a method according to one embodiment. It is readily understood that the complexity of the method will increase as the number of levels in a corresponding hierarchical structure increases. Thus, the method illustrated by FIG. 4 should be regarded as exemplary, and similar methods related to more or less complex hierarchical structures are readily understood when reading the description below with reference to FIG. 4.

In a displaying step 400, a first list of items belonging to a higher hierarchical level is displayed. Thus, in a selection enablement step 402, a user is enabled to make a selection of a first item among the higher hierarchical level items, wherein it is checked 404 whether any selection is made. Thus, selection enablement step 402 is processed until there has been a selection. It can also be checked 406 if selection indicates that information associated with the selected item should be rendered directly. If that is the case, a rendering step 408 will be processed. Otherwise, a second list of items is inserted and displayed between the first item and subsequent items of the higher hierarchical level in the display view in displaying step 410, wherein the second list comprises items hierarchically associated with the selected first item. Thus, in a second selection enablement step 412, a user is enabled to make a selection of a second item among the displayed items, wherein it is checked 414 whether any selection is made. Thus, the selection enablement step 412 is processed until there has been a selection.

Optionally, there can be checked 416 if the selection is made of an item from the first list, wherein a list of items hierarchically associated with the selected item is inserted and displayed between the selected item and subsequent items of the higher hierarchical level, or, if the selected item is the first item, concealing the second list and thus returning to displaying step 400.

It can also be checked 418 if selection indicates that information associated with the selected item should be rendered directly. If that is the case, a rendering step 408 will be processed. Otherwise, a third list of items is inserted and displayed between the selected item and subsequent items in the displaying view in displaying step 420.

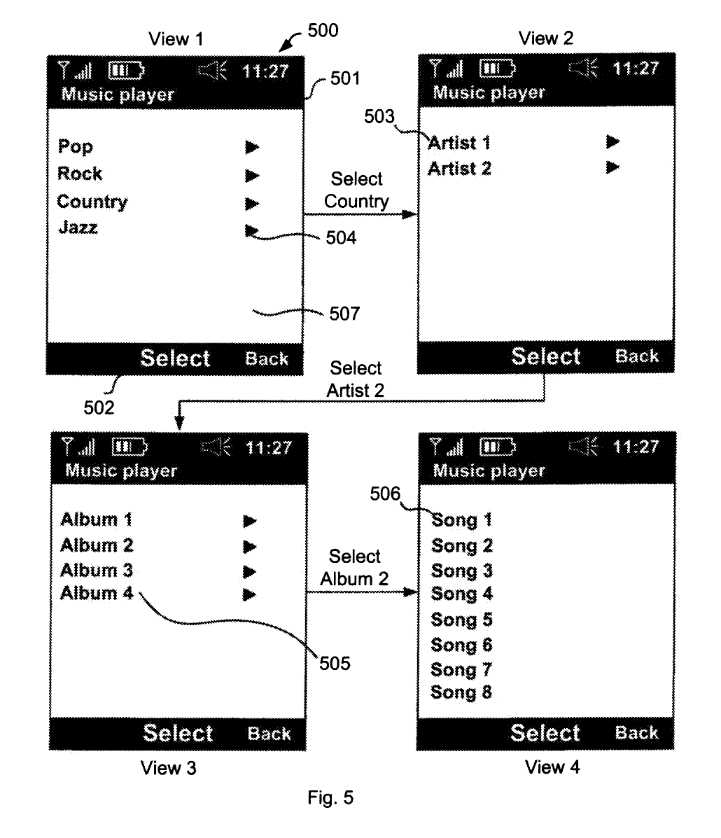

FIG. 5 illustrates an example of a common display view in a mobile communication apparatus 500 comprising a general status indication section 501, a softkey bar 502 and a general display area 507. The general status indication section 501 can for example include symbols for battery status, reception quality, speaker on/off, present mode, clock time, etc. The status indication section is not in any way limited to only include these symbols. Thus, other symbols in any shape, form or colour can occur. The softkey bar 502, situated at the bottom of the display view, is operable using the navigation means 104 mentioned in conjunction with FIG. 1. The function of these softkeys are not limited by the functions indicated in the figure.

The preferred function of the general display area 507, residing between the status indication section 500 at the top and the softkey bar 502 at the bottom, is to display information from running applications in the mobile communication apparatus. In our case the display area 507 displays lists of items which are maneuverable with the aid of the navigation means 104 in FIG. 1.

Throughout this disclosure, references have been made to a hierarchical structure. The hierarchical structure can be fixed by a specification or application, or dynamically assigned, as will be discussed below.

The navigation and the dynamics of the hierarchy structure will be explained by an series of examples, all in a context of a music library. However, as will be readily understood by a skilled person, the principle applies in a similar way to other contexts, such as phone books, photo albums, web link collections, To Do lists, etc.

A music track can have a set of meta data associated. The meta data can comprise name of artist, song title, album title, composer, producer, genre, etc.

In our example in FIG. 5, the display area further comprises a hierarchical item lists of meta data categories 503 with associated arrows 504 indicating further selectable sub levels of the hierarchically associated items. The user of the mobile communication apparatus can be prompted to select one of the meta data categories define as the highest level in the hierarchy. For example, the meta data category ‘Genre’ have been selected to be the top level. In view 1 a list of sub level items can then be displayed, such as ‘Pop’, ‘Rock’, ‘Country’, and ‘Jazz’. If a user then selects one of the items from the list, for example ‘Country’, a new display view appears, view 2, displaying a new sub level with, in this case, an item list of country artists 503. A further selection by the user, for example ‘Artist 2’, will in its turn display a new display view, view 3, where a new hierarchical item list of albums, from that particular artist, which are hierarchical associated with the selected artist item is displayed. If the user for example selects the item ‘Album 2’ a new display view, view 4, showing a list of items of songs hierarchically related to the selected album list item appears. The songs, which in this particular example is on the lowest level in the hierarchy, can be rendered.

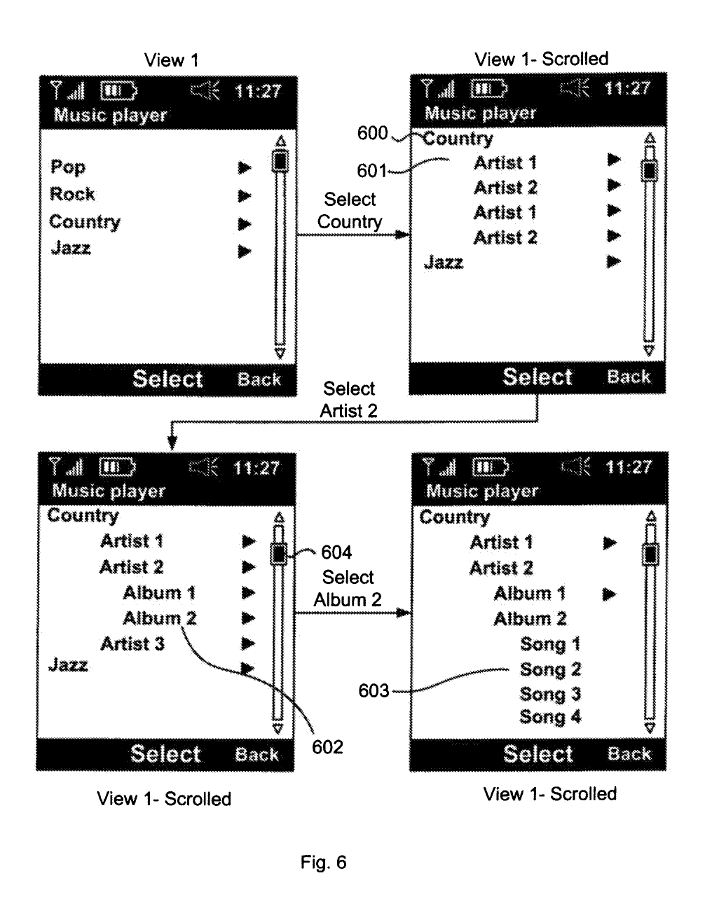

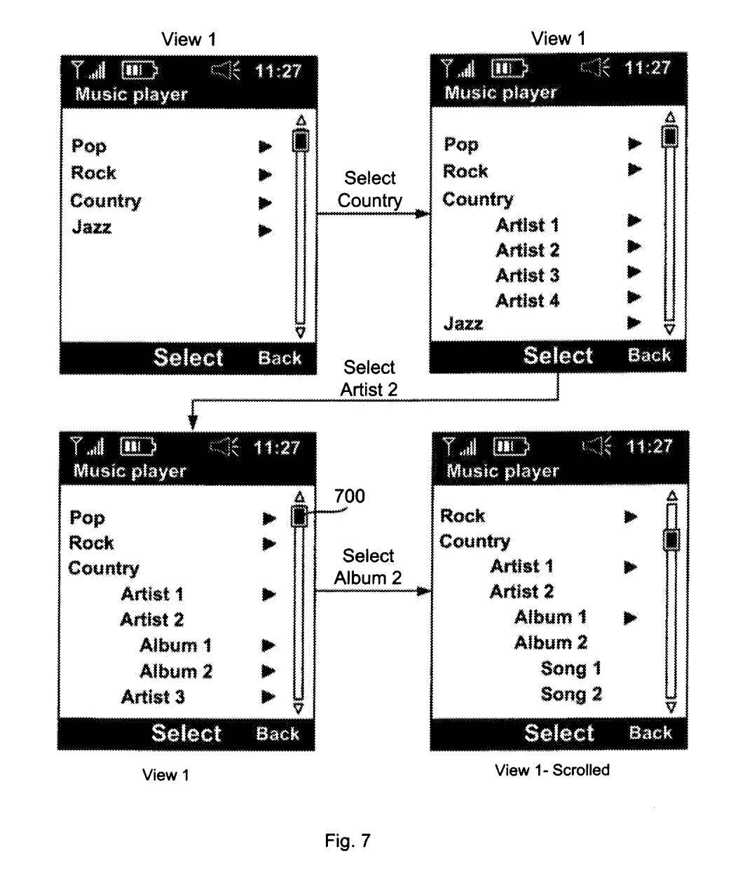

FIG. 6 shows another embodiment. The common display area is the same as in the example in FIG. 5, and the same hierarchically associated item lists with meta data are used as in the example in FIG. 5. A user can be prompted to selects one of several meta data categories, such as ‘Pop’, ‘Country’, ‘Rock’ and ‘Jazz’, to define the top or root level in the hierarchy. If a user selects the meta data item ‘Country’ 600, in view 1, from the top hierarchical items list, the whole items list with will be scrolled, within view 1, so that item ‘Country’ 601 is positioned at the top of the display area and an indented items list of artists 601 is inserted between the items ‘Country’ and ‘Jazz’. The scrolling of items indicated by a scroll bar 604 placed at the right hand side of the display area 604. If a user chooses to select item ‘Artist 2’ from said indented list of items, a new indented list of album items are inserted between said ‘Artist 2’ and ‘Artist 3’ 602. If item ‘Album 2’ is selected a new indented items list comprising song items 603 hierarchically related to the ‘Album 2’ items are inserted in the same manner, in said view 1. The displaying of the hierarchical associated items ‘Country’, ‘Artist 2’, ‘Album 2‘and ’ Song’, are all displayed as an indented tree structure in the same view of the display area, not in separate views as in the example in FIG. 5. The complete hierarchical tree structure is scrollable in the same view as indicated by the scroll bar 604. An example of scrolling the entire tree structure is shown in FIG. 7.

The tree structure makes navigating among the items very user friendly and it clearly shows how items are related to each other and where in the structure one are, which mitigates the effect of feeling lost in the tree structure. Note that this example comprises a plurality of levels, but the user can choose to have fewer, as well as more, levels for the dynamically selected hierarchy, depending on the desires of the user. In the example discussed above, a user has been able to set up the dynamically assigned hierarchy tree structure, but it is readily understood that this set-up can be made by an administrator of the media library, or which type of items to be structured, a service provider, or an operator.

FIG. 7 shows the same example of a hierarchical tree structure with indented list items of meta data as in FIG. 6, but more clearly showing how the scrollbar 700 can be utilized to scroll through the hierarchical structure and easily select items on different hierarchical levels without backing through a series of display views corresponding to the different levels in the hierarchy.

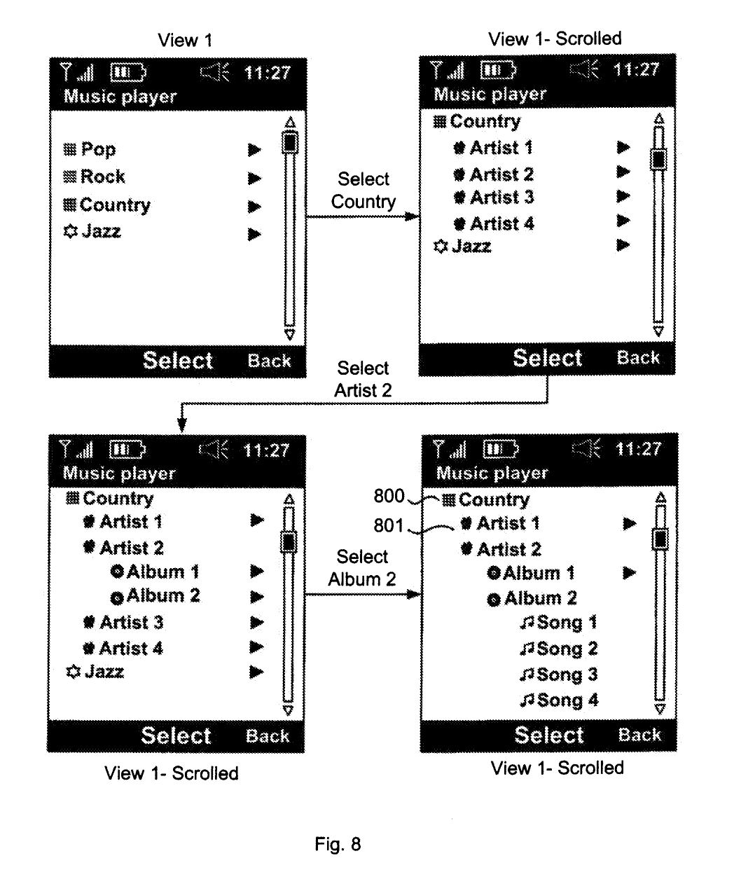

One way of enhancing the indenting the tree structure, and to give the user more visual cues of where in the hierarchical tree structure one resides, is to add a visual cue, such as an symbol, in front of similar items on the same level in the hierarchical structure. FIG. 8 shows one embodiment with added visual cues to similar items in the tree structure. In the example in FIG. 8 the visual cues are made up of different symbols. The ‘Country’ item on the top level in the tree structure is marked by a square checkered object 700 and the ‘Artist 1’ item is marked with a “crowd of people” object. However, visual cues are not limited to the symbols presented in the example in FIG. 8, or even symbols for that matter. They could consist of any type of differentiating object or marking such as animated objects, different font styles, different colorations of the fonts or different backgrounds of items belonging to the same level, etc. This enhancement to the indented tree structure is especially efficient to use in handheld devices with a larger display area such smart phones, PDAS, etc.

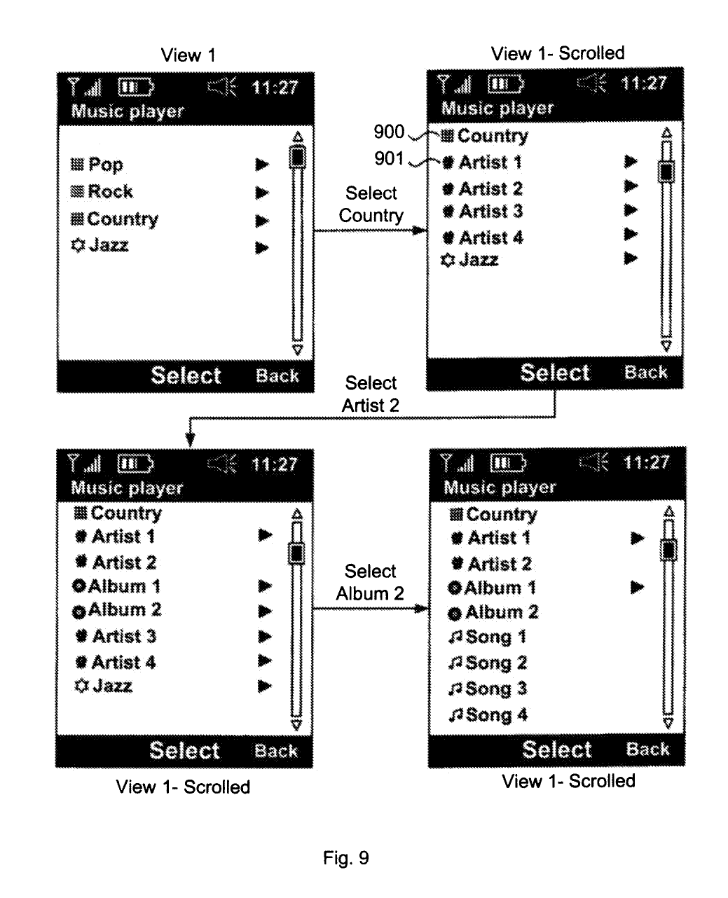

If the display area of the mobile communication apparatus is extremely precious, such as in a small sized cell phone, an alternative way of communicating the hierarchical level information is by using visual cues only and removing the indenting and thereby compacting the display space needed for the hierarchical structure. One example of this is shown in FIG. 9 where the visual cues are represented by symbols as in the example in FIG. 8. Each item list belonging to a specific hierarchical level share the same icon. For example the ‘Country’ item is indicated by a square checkered object 900 in front of the item name, the item ‘Artist l’ has a ‘crowd of people’ object 901 and so on. The symbol will in this case serve as a visual cue, and group similar items and indicate which level in the hierarchical tree structure the item or the group of items belongs to.

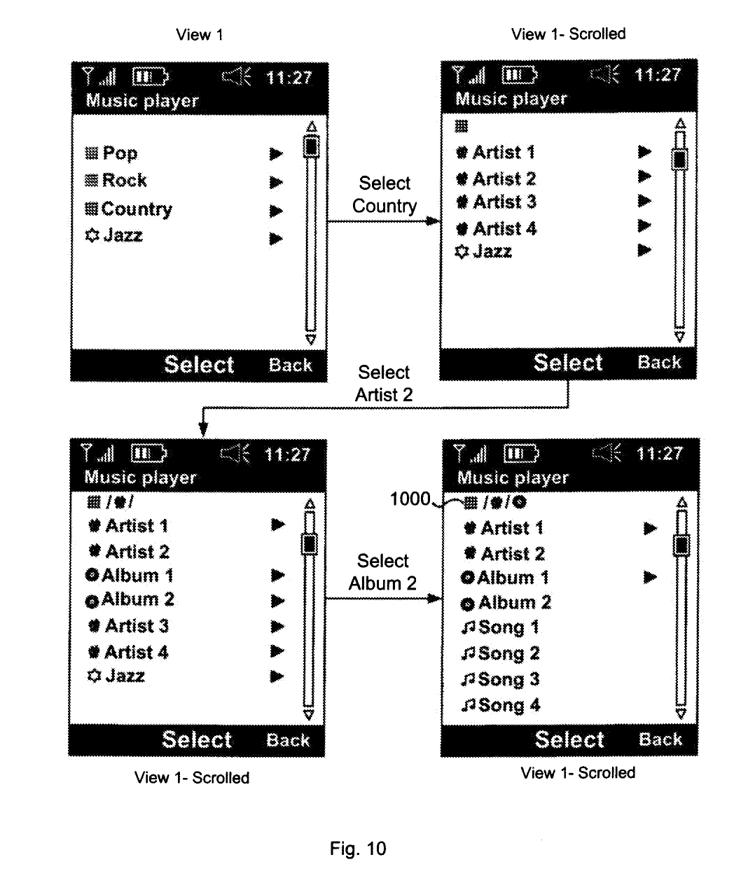

A way of enhancing the compacted hierarchical structure presented in FIG. 9 is to place a visual cue on the top of the display area which tells the user on which level in the hierarchical structure one are. One way is to place symbols, corresponding to the symbol representing a specific hierarchical level in the structure, separated by slashes to indicate on which level one are. FIG. 10 shows such an example where symbols are placed at the top of the display area 1000. In the example the symbols 1000 in the last display view communicate that the user have previous chosen the ‘Country’ level, ‘Artist’ level, ‘Album’ level and are currently in the ‘Song’ level. As in the case of the examples in FIG. 8 and FIG. 9 the visual cue does not have to be in the form of symbols only.

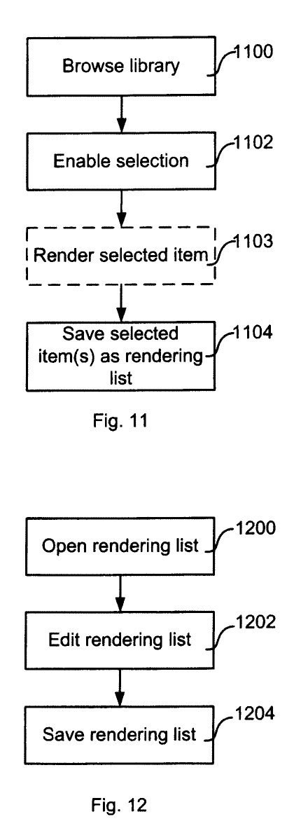

With reference to FIGS. 2 to 10, browsing and selection according to different embodiments of the invention have been demonstrated. FIG. 11 illustrates a method according to an embodiment with a schematic flow chart. One or more items are defined by a user by browsing 1100 and selecting 1102 items from a library comprising the items. The library can for example be a music library comprising song items being hierarchically arranged, as has been illustrated with reference to FIGS. 2 to 10. Optionally, the item can be rendered 1103 upon selection, e.g. as a ‘preview’ before definitely selecting the item. When the one or more items have been defined by browsing 1100 and selecting 1102, the items are saved 1104 as a rendering list, which in the example of the music library then is a play list that can be played instantly, at another time instant, or at repeated time instants.

The rendering list can be created after browsing 1100 and selecting 1102, i.e. at saving 1104. The rendering list can also be created before starting browsing 1100, wherein the created rendering list then just is saved 1104 when the user is satisfied with it.

FIG. 12 illustrates a method according to an embodiment, where a user has a saved rendering list since before, and wants to make amendments in the rendering list. The existing rendering list is opened 1200 and edited 1202. Edition can then comprise browsing and selecting, and optionally rendering, as have been demonstrated with reference to FIG. 11, which in turn can be embodied as has been demonstrated with reference to FIGS. 2 to 10. When the one or more items have been defined or re-defined, the rendering list is saved 1204.

As can be readily understood after taking part of the above disclosure, the disclosed embodiments are particularly suitable for implementing in software. Computer programs for browsing, selecting and saving a rendering list as demonstrated in the various disclosed embodiments herein executed by a processor connected to suitable input and output means are therefore considered as forming preferred embodiments.

1. A method comprising:
browsing a media library for desired media items;
selecting found desired media items from said media library; and
saving the selected media items as a play list.

2. The method according to claim 1, further comprising:
displaying a first list of items belonging to a dimension of said multi-dimensional hierarchy in a display view;
displaying a second list of items representing other dimensions of said multi-dimensional hierarchy in said display view;
enabling selection of a displayed item; upon selection of an item from said first list, displaying a third list of items belonging to a lower hierarchical level for enabling further selection of displayed items, wherein said third list is hierarchically associated with the selected item; and
upon selection of an item from said second list, displaying a fourth list of items belonging to a dimension of said multi-dimensional hierarchy associated with the selected item.

3. The method according to claim 2, further comprising rendering a media item associated with said selected item upon selection of said media item.

4. The method according to claim 2, further comprising indenting said inserted third list compared to said first list.

5. The method according to claim 2, further comprising, upon selection of an item from said second list, concealing said first list of items; and inserting into said second list of items an item representing the dimension of said concealed first list.

6. The method according to claim 1, further comprising opening an existing play list; and editing the existing play list by said browsing and selecting.

7. An application comprising:
a browser for a media library; a selector for selecting found desired media items from said media library; and
a saver for saving the selected media items in a memory as a play list.

8. The application according to claim 7, wherein the browser is arranged to cause a first list of items belonging to a dimension of a multi-dimensional hierarchy to be displayed, and a second list of items representing other dimensions of said multi-dimensional hierarchy to be displayed, wherein the browser may be capable of receiving a selection of a displayed item, and upon selection of an item from said first list, cause a third list of items belonging to a lower hierarchical level to be displayed for enabling further selection of displayed items, wherein said third list is hierarchically associated with the selected item; and upon selection of belonging to a dimension of said multi-dimensional hierarchy associated with the selected item to be displayed.

9. The application according to claim 8, arranged to render a media item associated with said selected item upon selection of said media item.

10. The application according to claim 8, further providing an indent to said inserted third list compared to said first list.

11. The application according to claim 7, further being arranged to open an existing play list and editing the existing play list, wherein editing comprises said browsing and selecting.

12. A portable apparatus comprising a display and an item navigation device arranged to enable navigation among items displayed on said display, the apparatus further comprising a browser for a media library; a selector for selecting found desired media items in said media library by said navigation device; and a memory for saving the selected media items as a play list.

13. The apparatus according to claim 12, wherein the browser is arranged to cause a first list of items belonging to a dimension of a multi-dimensional hierarchy to be displayed, and a second list of items representing other dimensions of said multi-dimensional hierarchy to be displayed, wherein the browser may be capable of receiving a selection of a displayed item, and upon selection of an item from said first list, cause a third list of items belonging to a lower hierarchical level to be displayed for enabling further selection of displayed items, wherein said third list is hierarchically associated with the selected item; and upon selection of an item from said second list, a fourth list of items belonging to a dimension of said multi-dimensional hierarchy associated with the selected item to be displayed.

14. The apparatus according to claim 13, comprising a media renderer, wherein said media renderer is arranged to render a media item associated with said selected item upon selection of said media item.

15. The apparatus according to claim 12, further being arranged to open an existing play list and an editor for editing the existing play list, wherein said editor utilises said browser and selector.

16. A computer-readable medium having computer-executable components comprising instructions for browsing a media library for desired media items;
selecting found desired media items; and
saving the selected media items as a play list.

17. The computer-readable medium according to claim 16, wherein said components further comprises instructions for
opening an existing play list; and
editing the existing play list by said browsing and selecting.
